(19) United States
(12) Patent Application Publication
(10) Pub. No.: US 2012/0160889 A1
(43) Pub. Date: Jun. 28, 2012

(54) Fastening Tool for Adjusting a Driving Depth of a Fastener

(75) Inventor: Isamu Tanji, Ibaraki (JP)

(73) Assignee: Hitachi Koki Co., Ltd., Tokyo (JP)

(21) Appl. No.: 13/335,529

(22) Filed: Dec. 22, 2011

(30) Foreign Application Priority Data
Dec. 28, 2010 (JP) 2010-294161

(51) Int. Cl. B25C 1/04

(52) U.S. Cl. 227/142

(57) ABSTRACT

A fastening tool includes a main body, a cylinder, a piston, a bumper, and an adjusting unit. The main body defines a compressed air chamber and an air damper chamber capable of communicating with the compressed air chamber through an air channel. The air channel has a cross-sectional area. The cylinder is provided in the main body. The piston slidably reciprocates between an upper dead center and a lower dead center in the cylinder. The bumper deforms to absorb energy of the piston when the piston is reaching the lower dead center. The energy of the piston is further absorbed by compressed air in the air damper chamber. The adjusting unit is configured to adjust the cross-sectional area.

### CROSS REFERENCE TO RELATED APPLICATION

This application claims priority from Japanese Patent Application No. 2010-294161 filed Dec. 28, 2010. The entire content of each of the priority application is incorporated herein by reference.

### TECHNICAL FIELD

The present invention relates to a driving tool for driving fasteners, such as nails or staples, into a workpiece.

### BACKGROUND

Some fastening tools disclosed in Japanese Unexamined Patent Application Publication No. 2004-351523 are mainly includes a piston, a drive blade used to impact the nail, a push lever in contact with a workpiece during a nail-driving operation, and a manual adjuster to adjust the driving depth of nails. The adjuster is for adjusting the length of the push lever such that the head of a nail driven into the workpiece is flush with the surface of the workpiece. The adjuster serves to adjust the depth at which a nail is driven by the fastening tool by adjusting how far the driver blade protrudes out through a nail-ejection opening formed in the end of the push lever.

Frequently when the nail-driving depth is adjusted with this type of adjuster, compressed air supplied from a compressor is used to generate high pressure. Consequently, the life of the fastening tool is reduced by kinetic energy in the piston that is not used up in the nail-driving operation (excess energy).

### SUMMARY

However, when driving nails into a soft workpiece using the fastening tool disclosed in Japanese Unexamined Patent Application Publication No. 2004-351523, the piston bumper deforms considerably to absorb a large amount of excess energy. Consequently, the piston bumper wears at a faster rate and the body of the nail-driving tool incurs a large impact, resulting in the piston bumper and the body of the nail-driving tool deteriorating more quickly.

In view of the foregoing, it is an object of the present embodiment to provide a fastening tool capable of improving the durability of the piston bumper while enabling the operator to easily adjust the fastener driving depth.

In order to attain the above and other objects, the present embodiment provides a fastening tool. The fastening tool includes a main body, a cylinder, a piston, a bumper, and an adjusting unit. The main body defines a compressed air chamber and an air damper chamber capable of communicating with the compressed air chamber through an air channel. The air channel has a cross-sectional area. The cylinder is provided in the main body. The piston slidably reciprocates between an upper dead center and a lower dead center in the cylinder. The bumper deforms to absorb an energy of the piston when the piston is reaching the lower dead center. The energy of the piston is further absorbed by compressed air in the air damper chamber. The adjusting unit is configured to adjust the cross-sectional area.

### BRIEF DESCRIPTION OF THE DRAWINGS

The particular features and advantages of the invention as well as other objects will become apparent from the following description taken in connection with the accompanying drawings, in which:

FIG. 1 is an external view showing an entire nail gun according to an embodiment of the present invention;

FIG. 2 is a partial cross-sectional view of the nail gun;

FIG. 3 is an enlarged cross-sectional view illustrating ambient to a piston bumper of the nail gun when a sliding member is in contact with a connecting part of the nail gun;

FIG. 4 is an enlarged cross-sectional view illustrating ambient to the piston bumper when the sliding member is away from the connecting part;

FIG. 5 is an enlarged cross-sectional view showing a trigger of the nail gun;

FIG. 6 is a cross-sectional view of a switch unit of the nail gun when a connection between a first channel and a second channel is blocked, taken along a line A-A of FIG. 2;

FIG. 7 is a cross-sectional view of the switch unit when the first channel and the second channel are in communication with each other, taken along the line A-A;

FIG. 8A is a cross-sectional view of a switching unit and a trigger valve when a connecting channel between a first air channel and a second air channel has a small cross-sectional area according to a first modification of the present invention;

FIG. 8B is a cross-sectional view of the switching unit, taken along a line B-B of FIG. 8A;

FIG. 9A is a cross-sectional view of the switching unit and the trigger valve when the connecting channel has a large cross-sectional area;

FIG. 9B is a cross-sectional view of the switching unit, taken along a line C-C of FIG. 9A; and

FIG. 10 is a cross-sectional view illustrating ambient to a piston damper according to a second modification of the present invention.

### DETAILED DESCRIPTION

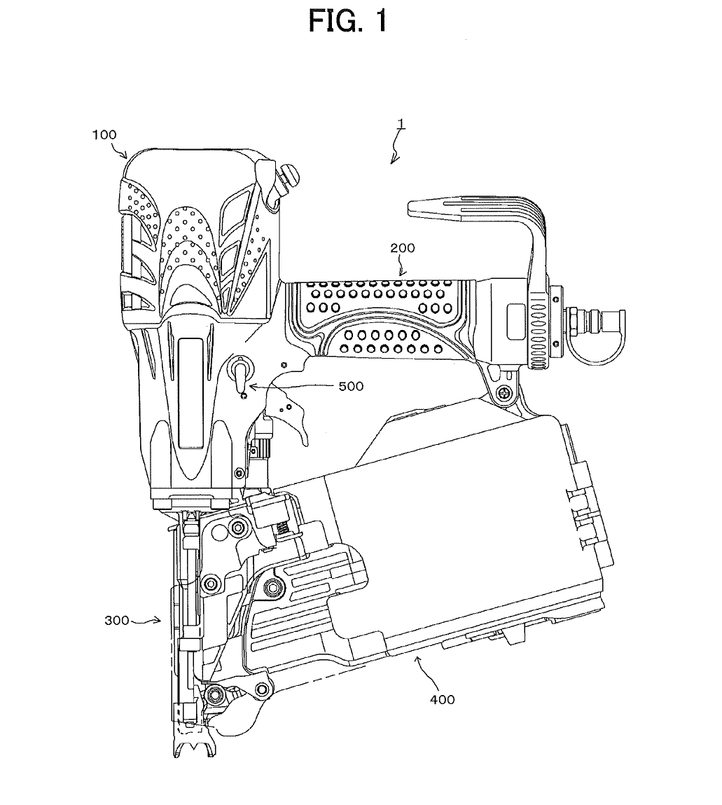

Next, a fastening tool according to a preferred embodiment of the present invention will be described while referring to the accompanying drawings. The fastening tool shown in FIG. 1 is a nail gun 1. The nail gun 1 functions to drive nails, serving as fasteners in the preferred embodiment, into a workpiece. The force used to drive the nails is pneumatically generated.

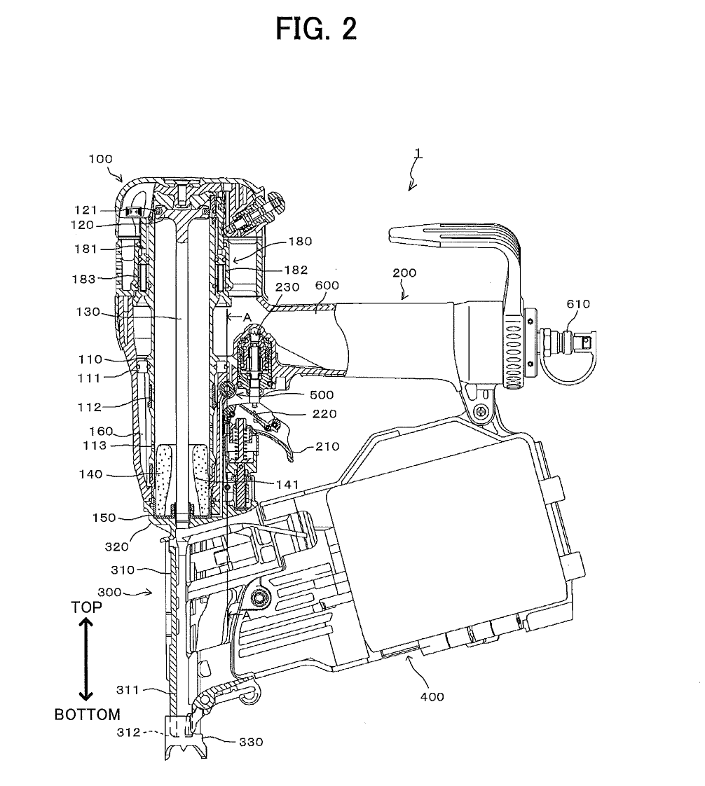

As shown in FIGS. 1 and 2, the nail gun 1 is primarily configured of a main body (housing) 100, a handle section 200 extending in a direction substantially orthogonal to the sliding direction of a piston 120 described later, a nose section 300 oriented in a general direction orthogonal to the surface of a workpiece (not shown) when driving a nail into the workpiece, a magazine 400 accommodating nails that are supplied to the nose section 300, and a switch unit 500 for switching the driving depth of the nails. In the following description, it will be assumed that the nail gun 1 is oriented such that the direction from the housing 100 toward the nose section 300 (the sliding direction of the piston 120) is vertically downward, while the opposite direction is vertically upward.

As illustrated in the cross-sectional view in FIG. 2, a compressed air chamber 600 is formed in the housing 100 and the handle section 200 of the nail gun 1 for accumulating compressed air. The compressed air chamber 600 is connected to an air compressor (not shown) via a plug 610 provided at the end of the handle section 200 and an air hose (not shown) connectable to the plug 610 and accumulates compressed air supplied by the air compressor.

The housing 100 houses a cylinder 110, a piston 120 that can slidably reciprocate up and down in the cylinder 110, a driver blade 130 formed integrally with the piston 120, a piston bumper 140 provided on the bottom end of the cylinder 110, and a sliding member 150 disposed below the piston bumper 140.

The cylinder 110 has an inner surface slidably supporting the piston 120. An annular cylinder plate 111 is disposed between an outer circumferential surface of the cylinder 110 and an inner surface of the housing 100. The cylinder plate 111 functions to divide the space formed between an outer surface of the cylinder 110 and the inner surface of the housing 100 vertically into an upper space and a lower space and to form a seal between the upper and the lower spaces. The upper space divided by the cylinder plate 111 forms the compressed air chamber 600 in conjunction with the space in the handle section 200. The lower space forms a return-air chamber 160 for collecting compressed air required to return the piston 120 to its upper dead center. The cylinder 110 has an axial center portion provided with a check valve 112. The check valve 112 allows compressed air to flow only in a direction from an interior of the cylinder 110 into the return-air chamber 160 outside the cylinder 110. The cylinder 110 has a bottom portion formed with an air passage 113 opening to the return-air chamber 160 at all times.

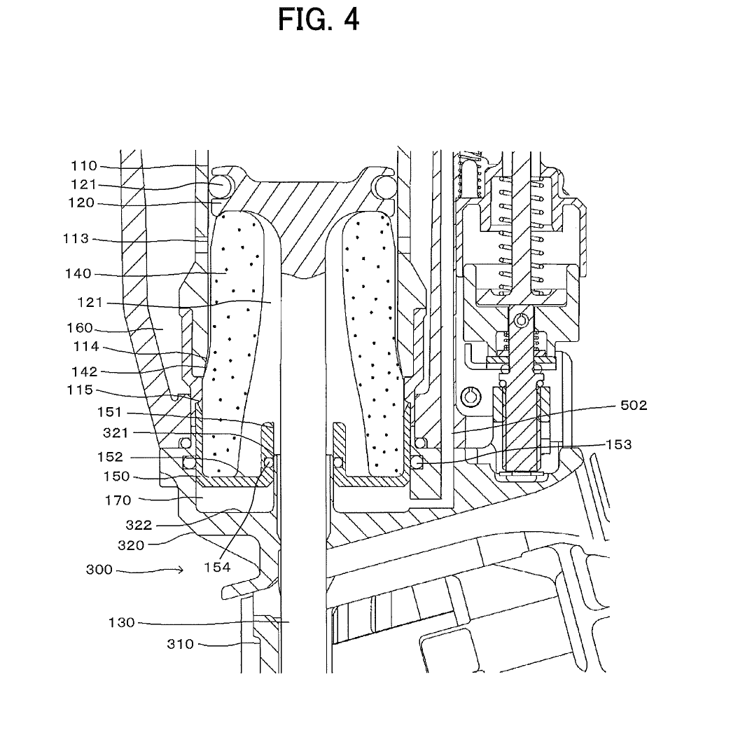

As shown in FIG. 4, a sloped part 114 is formed in the bottom portion of the cylinder 110. The sloped part 114 slopes at an angle substantially equivalent to the slope of a sloped part 142 formed on an outer circumferential surface of the piston bumper 140. An engaging part 115 is provided immediately below the sloped part 142 in order to restrict an upward movement of the sliding member 150. The engaging part 115 protrudes radially inward from the inner peripheral surface of the cylinder 110.

The piston 120 is disposed inside the cylinder 110 and is vertically slidable between the upper dead center and a lower dead center. The piston 120 has an outer circumferential surface provide with an O-ring 121. The driver blade 130 is integrally formed with a bottom surface of the piston 120, extending downward from a general center of the bottom surface. The piston 120 divides the interior of the cylinder 110 into an upper piston chamber and a lower piston chamber. The O-ring 121 seals the upper piston chamber from the lower piston chamber. During a nail-driving operation, compressed air flows into the upper piston chamber, forcing the piston 120 rapidly downward. The driver blade 130 also moves rapidly downward together with the piston 120, moving within an ejection channel 311 described later to impact a nail.

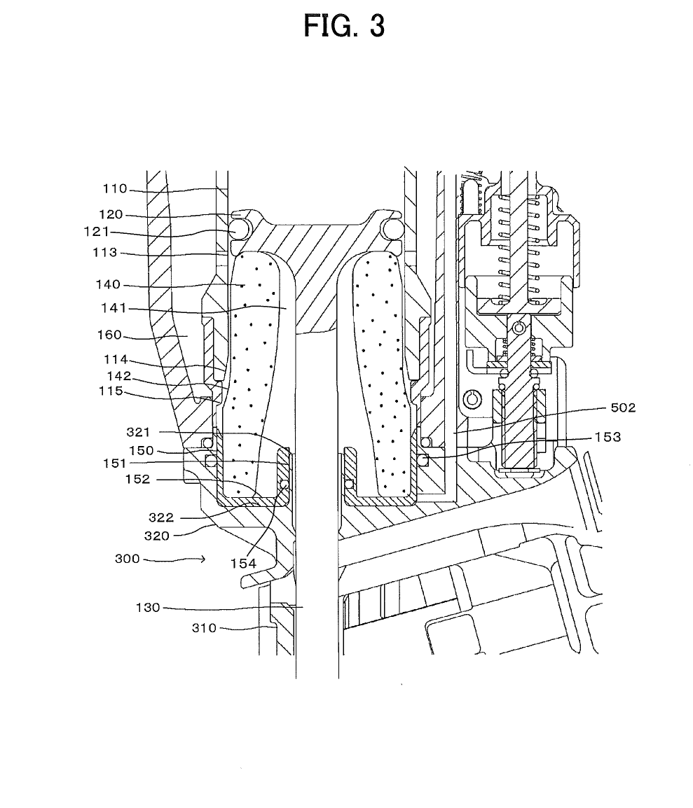

The piston bumper 140 is provided on a bottom edge of the cylinder 110 near the lower dead center of the piston 120. The piston bumper 140 is formed of an elastic material, such as rubber, and functions to absorb an excess energy of the piston 120 calculated by subtracting an energy possessed by the piston 120 propelled downward by compressed air from an energy expended by striking the nail. The piston bumper 140 has a center region formed with a through-hole 141 along the central axis of the cylinder 110 for inserting the driver blade 130. As shown in FIGS. 3 and 4, the sloped part 142 slopes so that the outer diameter of the piston bumper 140 grows smaller in the upward direction.

The sliding member 150 is disposed beneath the piston bumper 140 and is capable of sliding vertically. The sliding member 150 is annular in shape. As shown in FIGS. 3 and 4, the sliding member 150 has a center region formed with a through-hole 151 for receiving the driver blade 130. The sliding member 150 also has an annular recessed part 152 formed in the top thereof. The bottom end of the annular piston bumper 140 is positioned in the recessed part 152. The sliding member 150 has an outer peripheral surface provided with an O ring 153. An O ring 154 is provided around the through-hole 151.

When compressed air is introduced beneath the sliding member 150, an air damper chamber 170 is formed beneath the sliding member 150, as illustrated in FIG. 4. The air damper chamber 170 is defined by the sliding member 150 and a recessed part 322 of the nose section 300 described later. The air damper chamber 170 is hermetically sealed from the lower piston chamber by the O rings 153, 154 of the sliding member 150. The switch unit 500 controls the flow of compressed air into the air damper chamber 170. When compressed air has been introduced into the air damper chamber 170, the air damper chamber 170 functions as a damper to absorb the excess energy in the piston 120 during the nail-driving operation through the piston bumper 140 and the sliding member 150.

As shown in FIG. 3, the sliding member 150 is fitted into the recessed part 322 of the nose section 300 when compressed air has not been introduced into the air damper chamber 170. If compressed air is subsequently introduced into the air damper chamber 170 from this state, the sliding member 150 rises upward by the force of compressed air, as shown in FIG. 4. The top edge of the sliding member 150 is then in abutment with the engaging part 115. When the sliding member 150 receives a downward force from the piston 120 via the piston bumper 140 during the nail-driving operation while compressed air is present in the air damper chamber 170, the sliding member 150 moves first downward and subsequently moves back upward due to the compressed air in the air damper chamber 170.

As shown in FIG. 2, a main valve 180 is provided on top of the cylinder 110 for switching whether compressed air is supplied into or exhausted from the upper piston chamber. The main valve 180 includes a valve member 181, a main valve chamber 182, and a spring 183 disposed in the main valve chamber 182 for urging the valve member 181 upward. A trigger valve 230 described later switches the main valve chamber 182 between a state in communication with the compressed air chamber 600 and a state in communication with the atmosphere. When the main valve chamber 182 is in communication with the compressed air chamber 600, the valve member 181 is positioned in its upper dead center by the urging force of the spring 183 and compressed air in the main valve chamber 182. In this state, the upper piston chamber is in communication with the atmosphere. On the other hand, when the main valve chamber 182 is in communication with the atmosphere, the valve member 181 is moved to its lower dead center against the urging force of the spring 183 by compressed air applied to the top portion of the valve member 181. In this state, communication between the upper piston chamber and the atmosphere is interrupted, and a gap formed by moving the valve member 181 from its upper dead center to its lower dead center allows compressed air to flow into the upper piston chamber.

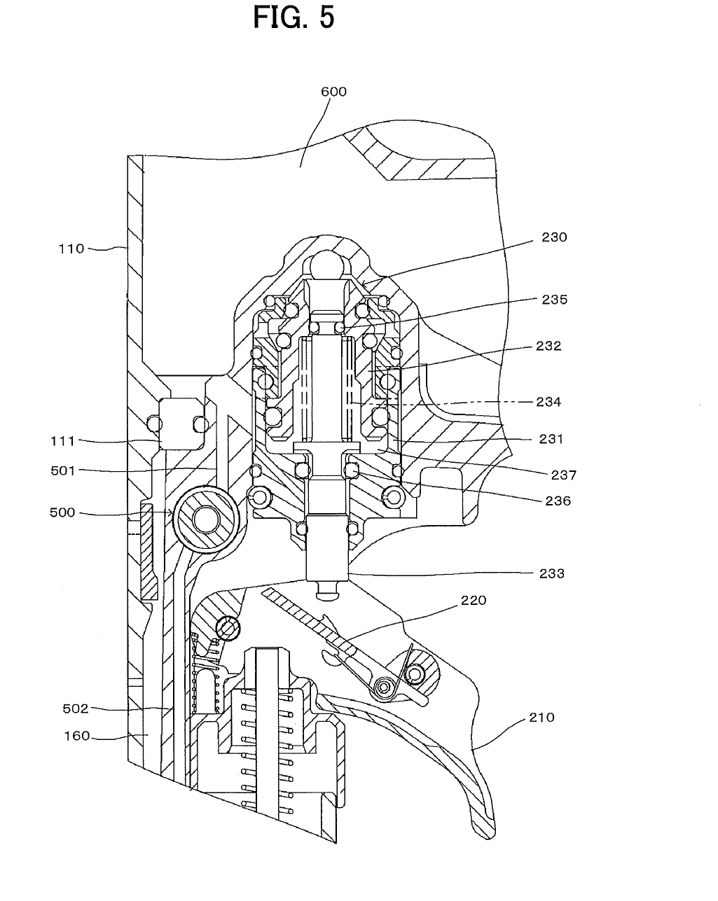

The handle section 200 is a portion of the nail gun 1 gripped by the operator. As shown in FIG. 5, the portion of the handle section 200 that is connected to the housing 100 includes a trigger 210 that is manipulated by the operator, an arm plate 220 pivotably provided on the trigger 210, and the trigger valve 230 configured of a diverter valve in communication with the main valve 180 for changing whether compressed air is supplied to or exhausted from the main valve chamber 182.

The trigger 210 is pivotably provided in the housing 100. When the operator pulls the trigger 210, the arm plate 220 moves a plunger 233 of the trigger valve 230 described below upward.

The trigger valve 230 is configured of a valve bushing 231, a valve piston 232, the plunger 233, a spring 234, O-rings 235 and 236, and a trigger valve chamber 237 in communication with the main valve chamber 182. While the operator is not pulling the trigger 210 and not pushing a push lever 330 described later against a workpiece, the valve piston 232 is in its upper dead center and the plunger 233 in its lower dead center. In this state, a gap between the valve piston 232 and O-ring 235 is closed, interrupting communication between the trigger valve chamber 237 and the atmosphere, and compressed air in the compressed air chamber 600 flows into the trigger valve chamber 237 through a gap formed between the plunger 233 and O-ring 236. The compressed air also flows into the main valve chamber 182.

On the other hand, when the operator is pulling the trigger 210 and pressing the push lever 330 against the workpiece, the valve piston 232 is in its lower dead center and the plunger 233 is in its upper dead center. In this state, a gap is formed between the valve piston 232 and the O-ring 235, opening communication between the trigger valve chamber 237 and the atmosphere so that compressed air is exhausted from the trigger valve chamber 237. At the same time, the gap between the plunger 233 and O-ring 236 is closed, interrupting communication between the trigger valve chamber 237 and compressed air chamber 600. The main valve chamber 182, which has communicated with the trigger valve chamber 237, is now in communication with the atmosphere, allowing compressed air to be exhausted from the main valve chamber 182.

As shown in FIG. 2, the nose section 300 guides the nail and the driver blade 130 so that the driver blade 130 reliably contacts the nail and drives the nail at a desired position in the workpiece. The nose section 300 is configured of an ejection unit 310, a connecting part 320 connecting the ejection unit 310 to the housing 100, and the push lever 330 capable of moving vertically along an outer surface of the ejection unit 310.

The ejection unit 310 functions to guide the driver blade 130 and nails supplied from the magazine 400 so that the nails are driven downward. The ejection unit 310 is formed internally with an ejection channel 311 for guiding a nail and the driver blade 130. The ejection unit 310 has a bottom end portion formed with an ejection hole 312 from which nails are ejected.

The connecting part 320 is arranged so as to cover an opening formed in the bottom of the housing 100. As shown in FIGS. 3 and 4, the connecting part 320 has a top surface formed with a through-hole 321 for inserting the driver blade 130. The annular recessed part 322 is formed around the periphery of the through-hole 321 as a downward recess in the connecting part 320. The sliding member 150 fits into the recessed part 322. The air damper chamber 170 described earlier is defined by the recessed part 322 and the bottom surface of the sliding member 150.

The push lever 330 protrudes downward below the bottom end of the ejection hole 312 and extends upward around the periphery of the ejection unit 310 to a position near the arm plate 220. The push lever 330 is capable of moving up and down, but is urged downward by a spring (not shown). When the operator presses the bottom end of the push lever 330 against the workpiece, an upper end of the push lever 330 moves a push lever plunger (not shown) upward. As the push lever plunger moves upward, the top end of the plunger in turn contacts the arm plate 220. When the operator pulls the trigger 210 in this state, the arm plate 220 contacts the plunger 233 of the trigger valve 230 and moves the plunger 233 upward. As a result, compressed air flows into the upper piston chamber, as described above, initiating a nail-driving operation.

The magazine 400 accommodates a plurality of nails that are bundled together. As shown in FIG. 2, the magazine 400 is provided below the handle section 200. A feeder (not shown) that is made to reciprocate by compressed air and an elastic member supplies nails from the magazine 400 to the ejection channel 311 one after another.

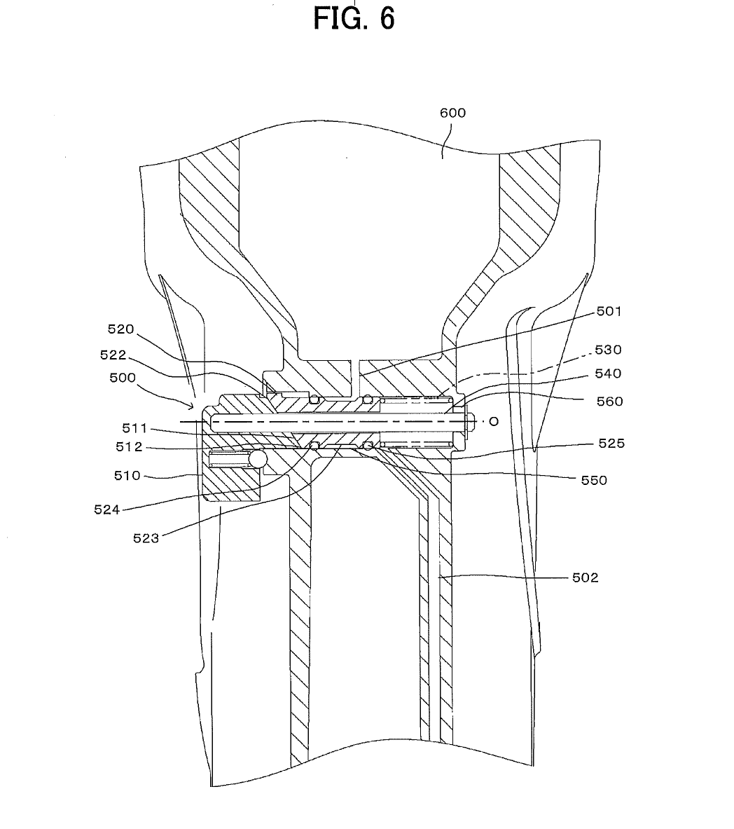

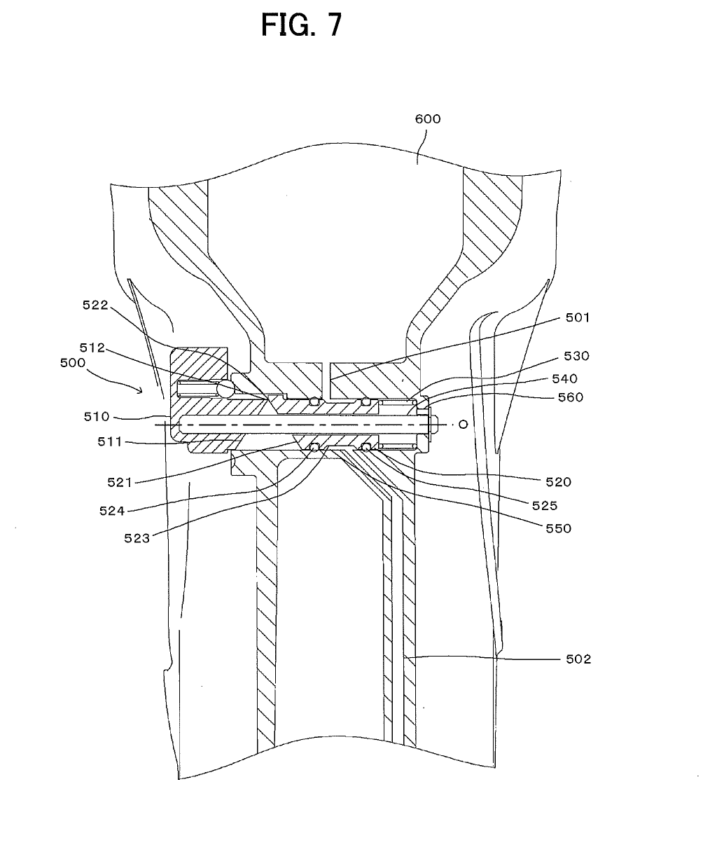

The switch unit 500 is a valve for opening and closing communication between a first air channel 501 and a second air channel 502 as shown in FIGS. 6 and 7. The first air channel 501 communicates with the compressed air chamber 600, while the second air channel 502 communicates with the air damper chamber 170. The switch unit 500 is configured of a selector knob 510, a valve member 520, a spring 530, and a rotating shaft 540.

The selector knob 510 is provided on the housing 100 so as to be capable of rotating about the rotating shaft 540. The operator manipulates the selector knob 510 to adjust the nail-driving depth. The selector knob 510 has an end portion provided with a sloped surface 511 opposing the valve member 520. The sloped surface 511 is sloped in relation to a central axis O of the rotating shaft 540, i.e., the sloped surface 511 is sloped in relation to a plane orthogonal to the central axis O. The sloped surface 511 has a protruding part 512 constituting the edge that protrudes farthest toward the valve member 520. An outlet 560 in communication with the atmosphere is formed at a rear side of the spring 530.

The valve member 520 is inserted into a channel 550 formed between the first air channel 501 and the second air channel 502. The valve member 520 similarly has a sloped surface 521 sloped in relation to the central axis O of the rotating shaft 540. The sloped surface 521 is formed on the end of the valve member 520 that opposes the selector knob 510 and has a protruding part 522 constituting the edge that protrudes farthest toward the selector knob 510.

The valve member 520 has an outer peripheral surface provided with O rings 524, 525. An annular recessed part 523 is formed in the outer peripheral surface and is recessed radially inward to form a compressed air channel. The O rings 524, 525 are provided at one on either side of the recessed part 523, for hermetically sealing gaps formed between the compressed air channel formed by the recessed part 523 and the external air.

The spring 530 is provided inside the channel 550 for urging the valve member 520 in a direction toward the selector knob 510 (leftward in FIGS. 6 and 7). The rotating shaft 540 supports the selector knob 510 so that the selector knob 510 can rotate relative to the housing 100.

When the selector knob 510 is in contact with the valve member 520, as shown in FIG. 6, with the sloped direction of the sloped surface 511 substantially equivalent to the sloped direction of the sloped surface 521 formed on the valve member 520, communication between the first and second air channels 501 and 502 is blocked. Here, the second air channel 502 is in communication with the atmosphere via the outlet 560.

If the selector knob 510 is subsequently rotated about 180° from this position, the protruding part 512 moves along the sloped surface 521 of the valve member 520, moving the valve member 520 in a direction away from the selector knob 510 (rightward in FIG. 6) against the urging force of the spring 530. As shown in FIG. 7, the protruding part 512 of the selector knob 510 is finally in contact with the protruding part 522 of the valve member 520, and the first and second air channels 501 and 502 communicate with each other via the compressed air channel. Here, compressed air in the compressed air chamber 600 is allowed to flow into the air damper chamber 170 via the first air channel 501, the recessed part 523 of the switch unit 500 (compressed air channel), and the second air channel 502, and simultaneously communication between the second air channel 502 and the outlet 560 is interrupted.

When the operator returns the selector knob 510 to an initial position as shown in FIG. 6, compressed air accumulated in the air damper chamber 170 is released to the atmosphere through the second air channel 502 and the outlet 560. Then, the sliding member 150 gradually moves its lower dead center as shown in FIG. 3 due to the weight thereof.

Next, operations of the nail gun 1 according to the preferred embodiment will be described.

First, the operations of the nail gun 1 will be described for a case in which the nail gun 1 receives a strong reaction force from a hard workpiece during a nail-driving operation, for example. In such a case, the operator rotates the selector knob 510 to the position shown in FIG. 6. In this position, the selector knob 510 and valve member 520 are in contact with each other along their respective sloped surfaces 511 and 521, with the sloped surfaces 511 and 521 sloped in substantially the same direction. In this state, communication between the first and second air channels 501 and 502 is interrupted and, hence, compressed air in the compressed air chamber 600 cannot flow into the recessed part 322 beneath the sliding member 150.

If the operator presses the push lever 330 against the hard workpiece and pulls the trigger 210 while the nail gun 1 is in this state, compressed air in the compressed air chamber 600 is allowed to flow into the upper piston chamber, forcing the piston 120 downward in the cylinder 110. At the same time, the driver blade 130 moves downward in the ejection channel 311 to impact the nail. At this time, air in the lower piston chamber flows into the return-air chamber 160 via the air passage 113. A portion of the compressed air in the upper piston chamber flows into the return-air chamber 160 through the check valve 112 when the piston 120 passes the check valve 112 and serves to return the piston 120 to its upper dead center.

Further, the driver blade 130 drives the nail downward into the hard workpiece. At this time, the nail gun 1 recoils upward greatly due to the reaction force of the nail-driving operation. However, since the tip of the driver blade 130 protrudes a considerable distance out of the ejection hole 312, the nail is reliably driven into the hard workpiece so that its head is flush with the surface of the hard workpiece. Subsequently, the piston 120 collides with the piston bumper 140 at its lower dead center. The piston bumper 140 deforms to absorb any excess energy remaining in the piston 120 after the nail-driving operation.

Next, the operations of the nail gun 1 will be described for a case in which the nail gun 1 receives a small reaction force from a soft workpiece during a nail-driving operation, for example. In such cases, the operator rotates the selector knob 510 to the state shown in FIG. 7, i.e., so that the protruding part 512 of the selector knob 510 is in contact with the protruding part 522 of the valve member 520. In this state, the first and second air channels 501 and 502 are in communication with each other. Accordingly, compressed air in the compressed air chamber 600 flows into the gap between the sliding member 150 and the top surface of the recessed part 322. The compressed air moves the sliding member 150 upward until the sliding member 150 engages with the engaging part 115, forming the air damper chamber 170, as shown in FIG. 4.

If the operator presses the push lever 330 against the soft workpiece and pulls the trigger 210 while the nail gun 1 is in this state, compressed air in the compressed air chamber 600 is allowed to flow into the upper piston chamber, forcing the piston 120 downward in the cylinder 110. At the same time, the driver blade 130 moves downward in the ejection channel 311 to impact the nail. At this time, air in the lower piston chamber flows into the return-air chamber 160 via the air passage 113. A portion of the compressed air in the upper piston chamber flows into the return-air chamber 160 through the check valve 112 when the piston 120 passes the check valve 112. The compressed air in the return-air chamber 160 is used to return the piston 120 to its upper dead center.

Further, the driver blade 130 drives the nail downward into the soft workpiece. At this time, the nail gun 1 recoils upward slightly due to the reaction force of the nail-driving operation. However, since the tip of the driver blade 130 protrudes only a small distance out of the ejection hole 312, reduced by a distance equivalent to the depth of the air damper chamber 170, the nail is driven into the soft workpiece so that its head is flush with the surface of the soft workpiece. Subsequently, the piston 120 collides with the piston bumper 140 at its lower dead center. The piston bumper 140 deforms to absorb any excess energy remaining in the piston 120 after the nail-driving operation. The sliding member 150 is also moved downward by the force of the piston 120 transferred via the piston bumper 140. The compressed air in the air damper chamber 170 absorbs a portion of the excess energy in the piston 120.

When the operator releases the trigger 210 or the push lever 330 separates from the soft workpiece, the main valve 180 moves its upper dead center. At the same time, the upper piston chamber is in communication with the atmosphere, and compressed air in the return-air chamber 160 flows back to the lower piston chamber through the air passage 113 so that the piston 120 returns to its upper dead center.

As described above, the nail gun 1 according to the preferred embodiment has the air damper chamber 170 disposed beneath the piston bumper 140, and the switch unit 500 for changing whether the air damper chamber 170 and compressed air chamber 600 are in communication or shut off from each other. Changing the switch unit 500 determines whether the air damper chamber 170 contains compressed air or does not contain compressed air.

Accordingly, when the nail gun 1 receives only a small reaction force from the soft workpiece during a nail-driving operation, the operator can reduce the length of the driver blade 130 that protrudes from the ejection hole 312 by adjusting the switch unit 500 so that the air damper chamber 170 contains compressed air, thereby adjusting the nail-driving depth so that a nail driven into the soft workpiece is flush with the surface of the soft workpiece. Any excess energy in the piston 120 following the nail-driving operation is absorbed by the piston bumper 140 and the compressed air contained in the air damper chamber 170. This configuration reduces wear on the piston bumper 140 since the amount of excess energy absorbed by the piston bumper 140 is less than when the air damper chamber 170 is not provided.

On the other hand, if the nail gun 1 receives a large reaction force during a nail-driving operation, the operator can increase the length of the driver blade 130 that protrudes from the ejection hole 312 by adjusting the switch unit 500 so that compressed air is not introduced into the air damper chamber 170, thereby adjusting the nail-driving depth so that the head of the nail driven into the hard workpiece is flush with the surface of the hard workpiece. Here, excess energy in the piston 120 following a nail-driving operation is absorbed solely by the sliding member 150. In this way, it is possible to adjust the nail-driving depth while increasing the durability of the piston bumper 140.

While the invention has been described in detail with reference to specific embodiments thereof, it would be apparent to those skilled in the art that many modifications and modifications may be made therein without departing from the spirit of the invention, the scope of which is defined by the attached claims.

For example, the switch unit 500 in the preferred embodiment can change whether the first and second air channels 501 and 502 are in communication or shut off from each other. However, the switch unit 500 is not limited to this structure, provided that the switch unit can adjust the nail-driving depth by adjusting the flow of compressed air between the air damper chamber 170 and the compressed air chamber 600.

Next, a modification of the switch unit 500 according to the preferred embodiment will be described. In this example, the cross-sectional area of the air channel between the air damper chamber 170 and return-air chamber 160 can be adjusted.

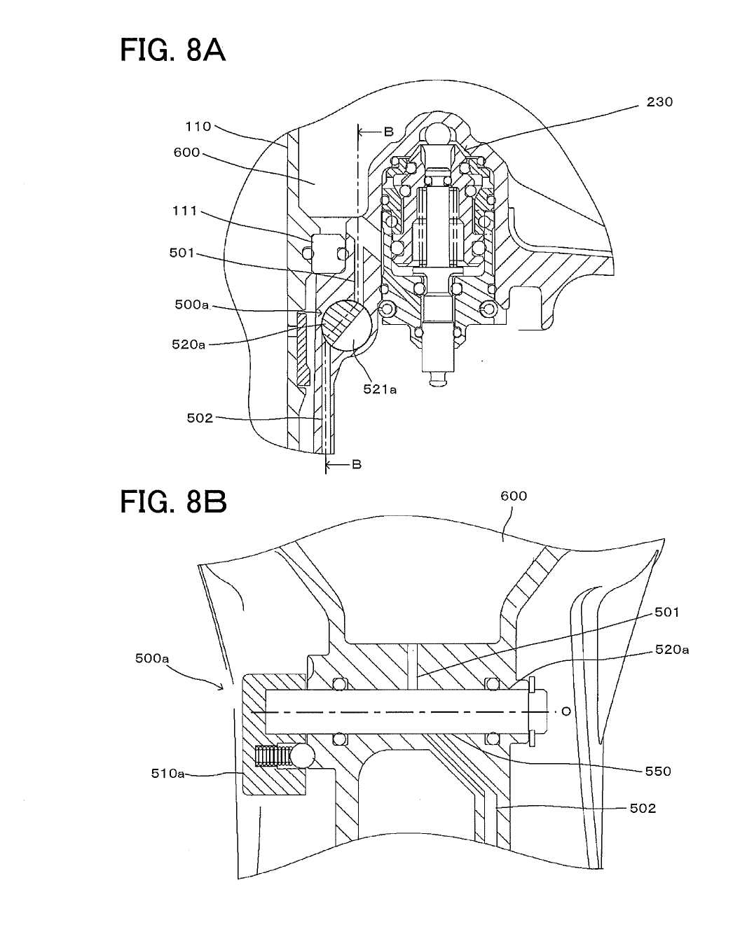

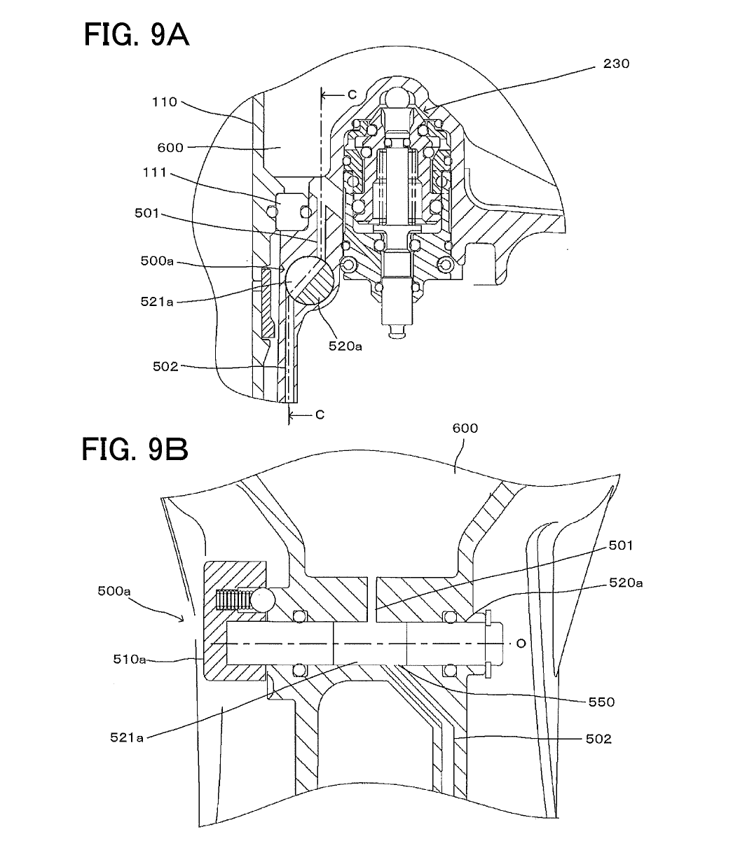

FIGS. 8A to 9B are cross-sectional views of a switch unit 500a serving as a modification of the switch unit 500. The switch unit 500a includes a selector knob 510a, and a valve member 520a that can rotate together with the selector knob 510a. As shown in FIGS. 8A and 9A, the valve member 520a is formed with a notched part 521a that is semicircular in shape when viewed along a central rotating axis O of the valve member 520a.

Hence, when the switch unit 500a is in the state shown in FIGS. 8A and 8B, compressed air can flow between the first and second air channels 501 and 502 through a narrow gap formed between an outer circumferential portion of the valve member 520a and the channel 550. This gap functions as a valve for just a few tens of millisecond, which is the extremely short length of time required to execute one nail-driving operation.

When the switch unit 500a is in the state shown in FIGS. 9A and 9B, on the other hand, compressed air can sufficiently flow between the first and second air channels 501 and 502 through the space formed between the notched part 521a and the channel 550.

The structure of the switch unit 500a described in the above modification can switch the cross-sectional area of the channel formed between the first and second air channels 501 and 502 between a small area, as shown in FIGS. 8A and 8B, and a large area, as shown in FIGS. 9A and 9B. If a nail-driving operation is performed while the nail gun 1 is in the state shown in FIGS. 8A and 8B, compressed air in the air damper chamber 170 receiving the driving energy from the piston 120 through the piston bumper 140 is less likely to flow toward the compressed air chamber 600 than when the nail gun 1 is in the state shown in FIGS. 9A and 9B.

When the housing 100 receives only a small reaction force from the soft workpiece during nail-driving operations, the operator can switch the nail gun 1 into the state shown in FIGS. 8A and 8B, thereby suppressing the returning flow of compressed air from the air damper chamber 170 into the compressed air chamber 600. This state reduces the length of the driver blade 130 that protrudes from the ejection hole 312 and can adjust the nail-driving depth so that the head of the nail is flush with the surface of the workpiece.

When the housing 100 receives a large reaction force during a nail-driving operation, on the other hand, the operator can switch the nail gun 1 to the state shown in FIGS. 9A and 9B so that compressed air in the air damper chamber 170 is allowed to sufficiently flow into the compressed air chamber 600 during nail-driving operations. In this state, the length of the driver blade 130 protruding out of the ejection hole 312 is greater, thereby adjusting the nail-driving depth so that the head of the nail driven into the workpiece is flush with the surface of the hard workpiece.

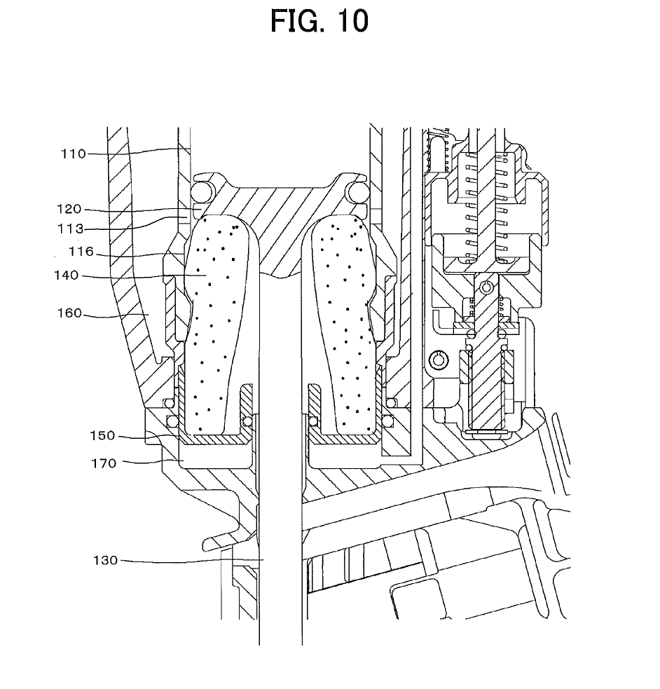

Further, the cylinder 110 in the preferred embodiment described above may also be provided with a recessed part 116, as shown in FIG. 10. The recessed part 116 is formed in the inner peripheral surface of the cylinder 110 immediately below the air passage 113. In this example, when the piston 120 impacts the piston bumper 140 while compressed air is present in the air damper chamber 170, the piston bumper 140 deforms while receiving a downward force from the piston 120 and is pressed into the recessed part 116. By entering the recessed part 116, the piston bumper 140 becomes engaged with the recessed part 116 and is restricted from moving downward. Consequently, the piston 120 is restricted from moving downward by the piston bumper 140, even when the compressed air in the air damper chamber 170 cannot absorb all of the excess energy in the piston 120 following a nail-driving operation, thereby preventing the nail from being driven too deeply into the workpiece.

What is claimed is:

1. A fastening tool comprising:
a main body defining a compressed air chamber and an air damper chamber capable of communicating with the compressed air chamber through an air channel having a cross-sectional area;
a cylinder provided in the main body;
a piston slidably reciprocating between an upper dead center and a lower dead center in the cylinder;
a bumper that deforms to absorb an energy of the piston when the piston is reaching the lower dead center, the energy of the piston being further absorbed by compressed air in the air damper chamber; and
an adjusting unit configured to adjust the cross-sectional area.

2. The fastening tool as claimed in claim 1, wherein the piston reciprocates in a first direction, and the bumper is movable in the first direction, a movement of the bumper being dependent on an amount of the compressed air in the air damper chamber.

3. The fastening tool as claimed in claim 2, wherein the air damper chamber comprises a sliding member movable in the first direction in accordance with introduction of compressed air in the air damper chamber.

4. The fastening tool as claimed in claim 3, wherein the piston divides the cylinder into an upper piston chamber and a lower piston chamber, wherein the sliding member is annular in shape and has a wall portion provided with a seal member for sealing the lower piston chamber from the air damper chamber.

5. The fastening tool as claimed in claim 1, wherein the adjusting unit includes a switching assembly for switching the air channel between an opening state and a closing state.

6. The fastening tool as claimed in claim 5, wherein the main body is formed with an outlet in communication with an atmosphere, wherein the switching assembly is configured to shut off a communication between the air damper chamber and the outlet during the opening state, whereas the switching assembly is configured to provide a connection between the air damper chamber and the outlet during the closing state.

7. The fastening tool as claimed in claim 6, wherein the switching assembly is configured to shut off a communication between the air channel and the outlet in the opening state, and to provide communication between the air channel and the outlet in the closing state

8. The fastening tool as claimed in claim 5, wherein the switching assembly comprises:
a valve member movable between a first position in which the air channel is at the opening state and a second position in which the air channel is at the closing state; and
a selector knob for selecting a position of the valve member.

9. The fastening tool as claimed in claim 8, wherein the switching assembly further comprises a spring urging the valve member from the first position to the second position in a second direction.

10. The fastening tool as claimed in claim 9, wherein the valve member has a valve sloped surface sloped relative to a plane orthogonal to the second direction,
wherein the selector knob has a knob sloped surface sloped relative to the plane,
wherein a sloped direction of the valve sloped surface is equal to a sloped direction of the knob sloped surface when the air channel is at the closing state, whereas the sloped direction of the valve sloped surface is unequal to the sloped direction of the knob sloped surface when the air channel is at the opening state.

11. The fastening tool as claimed in claim 5, wherein the bumper has an outer peripheral surface adjacent to an inner surface of the cylinder when the air channel is at the opening state.

12. The fastening tool as claimed in claim 1, wherein the adjusting unit includes a switching assembly for switching the air channel between a first state in which the air channel has a first cross-sectional area and a second state in which the air channel has a second cross-sectional area larger than the first cross-sectional area.

13. The fastening tool as claimed in claim 12, wherein the switching assembly includes:
a valve member movable between a first position in which the adjusting unit is at the first state and a second position in which the adjusting unit is at the second state; and
a selector knob for switching a position of the valve member.

14. The fastening tool as claimed in claim 13, wherein the valve member is formed with a notched part, the notched part being aligned with the air channel in the second state, whereas the notched part being offset from the air channel in the first state.

15. The fastening tool as claimed in claim 1, wherein the cylinder has an inner surface provided with a recess part depressed radially outward, a part of the bumper being pressed into the recess part upon the deformation of the bumper.
